(19) United States
(12) Patent Application Publication
(10) Pub. No.: US 2016/0210766 A1
(43) Pub. Date: Jul. 21, 2016

(54) METHOD FOR DISPLAYING TEXT AND GRAPH MESSAGE

(71) Applicant: YU-WEI HUANG, Chiayi (TW)

(72) Inventors: YU-WEI HUANG, Chiayi (TW); TSUNG-WEI KE, Kaohsiung (TW); YUEH-ER KE, Kaohsiung (TW); HUNG-WEI HSUEH, Chiayi (TW); BOR-YAN HUANG, Chiayi (TW)

(21) Appl. No.: 14/979,479

(22) Filed: Dec. 27, 2015

(30) Foreign Application Priority Data
Dec. 25, 2014 (TW) 103145523

(51) Int. Cl. G06T 11/20; G06F 17/21

(52) U.S. Cl. CPC G06T 11/206; G06F 17/212

(57) ABSTRACT

A method for displaying text and graph message is provided. In the present invention, with changing or adding effect for existing text or graph message by a user and displaying on the application programming interfaces of both sides, the performances of the situational effect of messages is increased, and the program of text and graph message exchange is more efficient for the purpose of better interactive communication.

### FIELD OF THE INVENTION

The present invention relates to text communication, and more particularly to a message processing program with digital text and graph communication.

### BACKGROUND OF THE INVENTION

In recent years, with the development of mobile data and smart handheld communication device, the transmission of text and image data becomes an indispensable part of digital chat software.

In the conventional chat software, users can input not only text messages but also images, files, voice files, and so on. Compared with analog voice transmission of traditional telephony, message chat software based on digital data undoubtedly has more possibilities of communication. However, the pattern of existing chat software is still unidirectional transmitted of user's intention. For example, if person A inputs a text or graph message, and then person B will input a personal text or graph message according to the received message. It still lacks for a real-time, bilateral, and simultaneous conversation and a communication type of co-operation.

For the purpose of better interactive communication and increasing the efficiency of text and graph message exchange, the inventors propose this application “METHOD FOR DISPLAYING TEXT AND GRAPH MESSAGE”. The brief description of the application is following.

### SUMMARY OF THE INVENTION

The purpose of present invention is for solving the disadvantages as above of the prior art.

Another purpose of the present invention is for increasing the efficiency of text and graph message exchange and providing a better pattern of situational communication.

Accordingly, an aspect of the present invention is to provide a method for displaying text and graph message performed by a first message host which comprises a first server, a first display, and a first communication device. The method comprises the steps of: (a) directing a displaying interface of an application of the first display to display a specific text message; (b) directing the first server to receive a label instruction which a user input for a specific segment of the specific text message, and to compute a first location index of the specific segment to the first display according to the label instruction; (c) directing the first server to receive a specific graph which the user selected for the specific segment, wherein the specific graph is prestored in a graph database and is corresponding to a specific graph identification number; (d) directing the first server to make the specific graph to be displayed on the displaying interface of the application at a specific relative location of the specific segment; and (e) directing the first communication device to transmit the first location index and the specific graph identification number to a second message host.

According to another aspect of the present invention, the specific graph comprises one of a dynamic graph or a static graph.

According to another aspect of the present invention, the specific text message is transmitted to the first message host by the second message host in the step (a).

According to another aspect of the present invention, in the step (e), the first communication device further transmits an application identification number and a user identification number to the second message host, wherein the second message host comprises a second server and a second display, the second display is able to display the displaying interface of the application, the second server selects the specific graph from the graph database according to the specific graph identification number and makes the specific graph to be displayed on the displaying interface of the application at the specific relative location of the specific segment.

According to another aspect of the present invention, in the step (e), the first communication device transmits a second location index to the second message host, wherein the second server makes the specific graph to be displayed on the displaying interface of the application of the second display according to the first location index and the second location index, and the second location index is for labeling the specific relative location.

According to another aspect of the present invention, further includes: (f) the first server make the specific graph to be hid from the displaying interface of the application according to a close instruction which is input by the user.

According to another aspect of the present invention, the first message host and the second message host can be a portable device (i.e., a smart phone, mobile phone, tablet, smart watch) and a personal computer.

Accordingly, another aspect of the present invention is to provide a method for displaying text and graph message performed by a first message host which comprises a first server and a first communication device. The method comprises the steps of: (a) directing the first server to make a first graph to be displayed on a displaying interface of an application; (b) directing the first server to receive a selecting instruction which a user input for the first graph, and to compute a first location index of the first graph on the displaying interface of the application according to the selecting instruction; (c) directing the first server to receive a second graph which the user selected from a prestored database, and the second graph is corresponding to a second graph identification number; (d) directing the first server to replace the first graph on the displaying interface of the application with the second graph; and (e) directing the first communication device to transmit the first location index and the second graph identification number to a second message host.

According to another aspect of the present invention, in the step (e), the first communication device further transmits an application identification number and a user identification number to the second message host, wherein the second message host comprises a second server, and the first graph is input by another user and is transmitted to the first display by the second communication device in the step (a).

According to another aspect of the present invention, further includes: (f) directing the second server to select the second graph from a prestored database according to the second graph identification number, and to replace the first graph with the second graph according to the first location index.

According to another aspect of the present invention, the second graph is a graph relative to the first graph. The graph type message can be selected from a group consisting of a static image, dynamic image, a animation without voice, a animation with voice and virtual reality image

According to another aspect of the present invention, the second graph is a dynamic graph, and the initial state of the dynamic graph is the first graph.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart of the first embodiment of the method for displaying text and graph message of the present invention;

FIG. 2 is a flowchart of the second embodiment of the method for displaying text and graph message of the present invention; and

FIG. 3 is a flowchart of the third embodiment of the method for displaying text and graph message of the present invention.

### DETAILED DESCRIPTION OF THE PREFERRED EMBODIMENTS

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

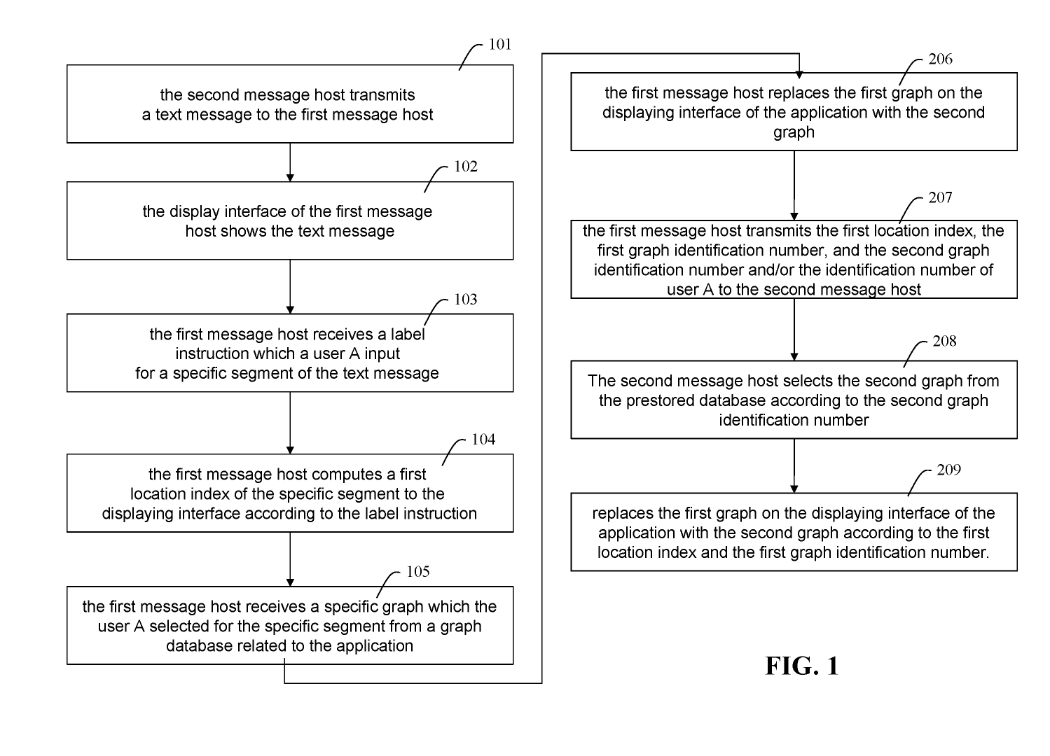

Refer to FIG. 1, which is a flowchart of the first embodiment of the method for displaying text and graph message of the present invention. In the FIG. 1, first, a second message host receives a text message such as “What boss said made me very angry” input by a user B, and makes the text message to be displayed on a displaying interface of an application, and then transmits the text message to a first message host (step 101). In the step 101, the second message host transmits the identification number of the application, the identification number of the user B, and the text message to the first message host.

After the first message host receives the text message, the first message host makes the text message to be displayed on the displaying interface of the application according to the identification number of the application (step 102), and the relationship between the text message and the user B is also displayed. Next, the first message host receives a label instruction which a user A input for a specific segment of the text message such as “very angry” (step 103). The label instruction is selected by a mouse or a cursor, or to be labeled by touching specific segment. Next, the first message host computes a first location index of the specific segment to the displaying interface of the application or to the text message according to the label instruction (step 104). The first location index is for indicating the location data of the specific segment. Then the first message host receives a specific graph which the user A selected for the specific segment from a graph database related to the application (step 105), such as a flame graph. The specific graph also has an identification number.

Next, the first message host makes the specific graph to be displayed on the displaying interface of the application at a specific relative location of the specific segment (step 106). For example, the flame graph covers the segment “very angry”. Then the first message host transmits the first location index, the identification number of the text message, the specific graph identification number, and/or the identification number of user A to the second message host (step 107). The second message host selects the specific graph prestored in the graph database according to the specific graph identification number (step 108), and makes the specific graph to be displayed on the displaying interface of the application at the specific relative location of the specific segment of the text message according to the first location index, the identification number of the text message, the specific graph identification number (step 109). For example, the text message “What boss said made me very angry” displayed in the second message host, wherein the segment “very angry” is also covered by the same flame graph displayed in the first message host.

In this embodiment, the specific graph is able to be a dynamic graph or a static graph. Users can select to display or hide the graph on the displaying interface of the application by inputting an instruction.

By labeling specific segments or texts and displaying graph, the semantics and situation of user's intention can be expressed more vividly for the purpose of better communication.

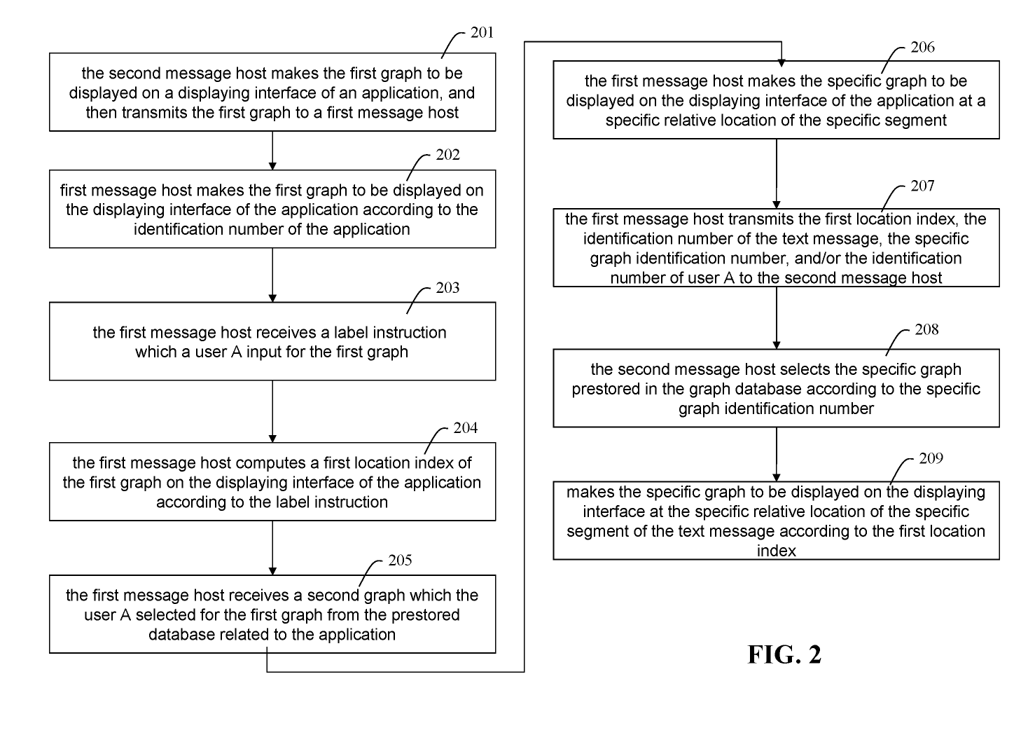

Refer to FIG. 2, which is a flowchart of the second embodiment of the method for displaying text and graph message of the present invention. In the FIG. 2, first, a second message host receives a first graph such as a flame graph selected by a user B from a prestored database, and makes the first graph to be displayed on a displaying interface of an application, and then transmits the first graph to a first message host (step 201). In the step 201, the second message host transmits the identification number of the application, the identification number of the user B, and the first graph identification number to a first message host.

After first message host receives the first graph, first message host makes the first graph to be displayed on the displaying interface of the application according to the identification number of the application (step 202), and the relationship between the first graph and the user B is also displayed. Next, the first message host receives a label instruction which a user A input for the first graph (step 203). The label instruction is selected by a mouse or a cursor, or to be labeled by touching the first graph. Next, the first message host computes a first location index of the first graph on the displaying interface of the application according to the label instruction (step 204). The first location index is for indicating the location data of the first graph. Then the first message host receives a second graph which the user A selected for the first graph from the prestored database related to the application (step 205), such as a flame-doused-by-rain graph. The second graph also has an identification number.

Next, the first message host replaces the first graph on the displaying interface of the application with the second graph (step 206). For example, the first message host replaces the flame graph with the flame-doused-by-rain graph. Then the first message host transmits the first location index, the first graph identification number, and the second graph identification number and/or the identification number of user A to the second message host (step 207). The second message host selects the second graph from the prestored database according to the second graph identification number (step 208), and replaces the first graph on the displaying interface of the application with the second graph according to the first location index and the first graph identification number.

In this embodiment, the graph is able to be a dynamic graph or a static graph. Users can select to display or hide the graph on the displaying interface of the application by inputting an instruction. In contrast, the graph type message can be selected from a group consisting of a static image, dynamic image, a animation without voice, a animation with voice and virtual reality image.

Furthermore, the second graph is a graph relative to the first graph. For example, the second graph is a dynamic graph, and the initial state of the dynamic graph is based on the first graph.

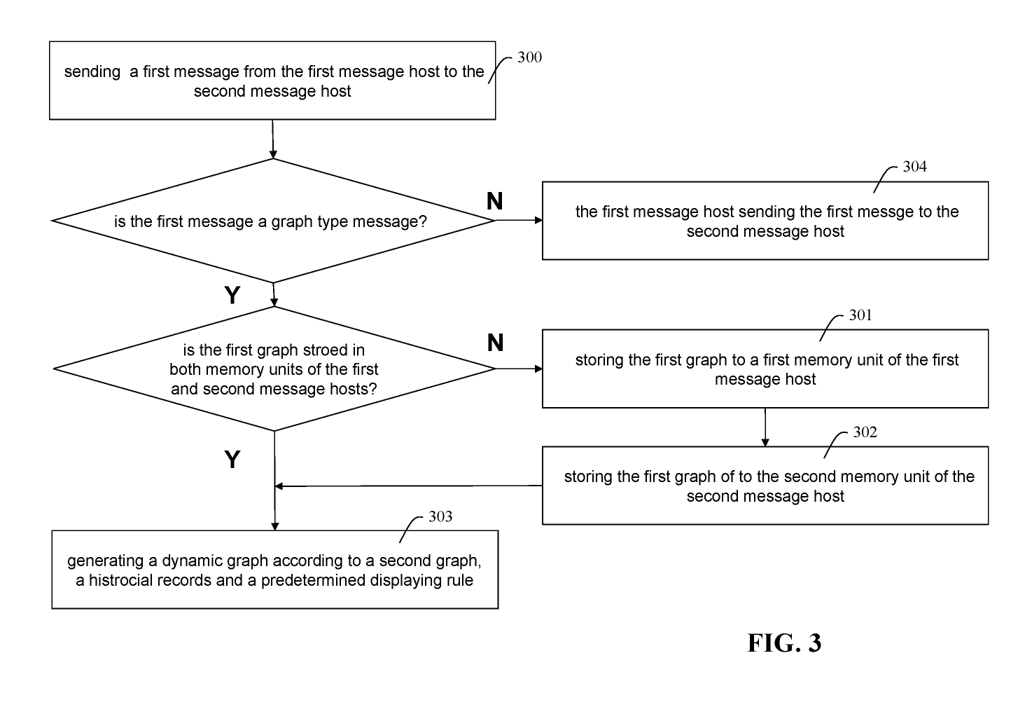

With reference to FIG. 3, the triggering of the dynamic graph from the initial state of the first graph in accordance with the present invention, the method further comprises steps of 300 sending a first graph of a first message from the first message host to the second message host; 301 storing the first graph to a first memory unit of the first message host when the first graph is not exist in the first memory unit; 302 storing the first graph of to the second memory unit of the second message host when the first graph is not exist in the second memory unit; and 303 generating a dynamic graph according to a second graph, a histrocial records and a predetermined displaying rule, wherein the second graph is sent from either the first message host or the second message host. The histroical records are the graphs stored in the first or second memory units.

The method further comprises steps of 304 the first message host sending the first message to the second message host when the first message is not a graph type message.

The group of rules comprises multiple predetermined displaying rules, and each displaying rule comprises corresponding IDs of graph messages. If there are multiple displaying rules being determined, 303 selecting the displaying rules with most overlapped IDs of graph messages comparing to the historcial records.

In one embodiment in accordance with the present invention, assuming that the histrocial record has six recent used IDs of graph messages with {ID1, ID2, ID3, ID4, ID8, ID9), and the group of rules R1˜R3 are:
R1{ID1, ID2, ID3);
R2{ID2, ID5, ID6};
R3{Id1, IR3, ID4}, wherein ID# are identical as IDs of the graph messages.

Accordingly, in this embodiment, when the ID of the first message is ID2, the R1 and R2 of displaying rules are determined, and displaying rule R3 is ignored due to the lack of ID2. The display rule R1 will be selected because it has most overlapped IDs of graph message with the histroical records. Therefore, the dynamic graph of the displaying rule R1 will be display when the second graph of the ID of the second graph are one of the ID1, ID2, or ID3.

In order to make the examiner easier to understand the triggering features of the dynamic graph, herebelow is an embodiment using a Rock-paper-scissors game for describing. The rule of Rock-paper-scissors game is predetermined in the displaying rule.

Assumed that the both historcial records of the first and second message hosts has a “scissor symbol” of the first graph (P1). When either the first or the second message sends a second graph (P2) with a “paper symbol”, a prestored dynamic graph will appear on both display interface with a appearance of a scissors cutting a paper.

Further, after the dynamic graph has been shown of the displaying interface, the users have to wait for a period of time until the dynamic graph disappears, or sends a interrupt message such as touching screen or click the mouse. In this embodiment, once the scissors cutting a paper dynamic graph has disappeared, the graph message with a “paper symbol” with replace the first graph (P1) in the histrocial records as a new first graph (P1). A new displaying rule will be re-determined based on the new first graph (P1).

Furthermore, the text message and the graph message are able to be displayed concurrently not only on the first message host and the second message host but also on third parties. It means that the graph message which the first message host inputs or converts can be displayed on plural message hosts which are involved in the message chat.

The above-mentioned message hosts comprise systems which include a server, a display, and a communication device, such as mobile phones, personal computers.

In the present invention, by users adding or converting graphs for specific text or graph, the text and graph message communication is more efficient. The performances of the situational effect of messages are also increased. As a result, the communication is more interesting, which improves the acceptance and the dependence of the application to users.

The above description should be considered as only the discussion of the preferred embodiments of the present invention. However, a person skilled in the art may make various modifications to the present invention. However, those modifications still fall within the spirit and scope defined by the appended claims.

What is claimed is:

1. A method for displaying text and graph message performed by a first message host which comprises a first server, a first display, and a first communication device, the method comprising the steps of:
(a) directing a displaying interface of an application of the first display to display a specific text message;
(b) directing the first server to receive a label instruction which a user input for a specific segment of the specific text message, and to compute a first location index of the specific segment to the first display according to the label instruction;
(c) directing the first server to receive a specific graph which the user selected for the specific segment, wherein the specific graph is prestored in a graph database and is corresponding to a specific graph identification number;
(d) directing the first server to make the specific graph to be displayed on the displaying interface of the application at a specific relative location of the specific segment; and
(e) directing the first communication device to transmit the first location index and the specific graph identification number to a second message host.

2. The method of claim 1, wherein the specific graph comprises one of a dynamic graph or a static graph.

3. The method of claim 1, wherein the specific text message is transmitted to the first message host by the second message host in the step (a).

4. The method of claim 1, wherein in the step (e), the first communication device further transmits an application identification number and a user identification number to the second message host, wherein the second message host comprises a second server and a second display, the second display is able to display the displaying interface of the application, the second server selects the specific graph from the graph database according to the specific graph identification number and makes the specific graph to be displayed on the displaying interface of the application at the specific relative location of the specific segment according to the first location index.

5. The method of claim 4, wherein in the step (e), the first communication device transmits a second location index to the second message host, wherein the second server makes the specific graph to be displayed on the displaying interface of the application of the second display according to the first location index and the second location index, and the second location index is for labeling the specific relative location.

6. The method of claim 1, further including:
(f) the first server make the specific graph to be hid from the displaying interface of the application according to a hiding instruction which is input by the user.

7. The method of claim 1, wherein the first message host and the second message host are a portable device or a personal computer, and the portable device is a device selected from a group consisting of a smart phone, a mobile phone, a tablet, and a smart watch.

8. A method for displaying text and graph message performed by a first message host which comprises a first server and a first communication device, the method comprising the steps of:
(a) directing the first server to make a first graph to be displayed on a displaying interface of an application;
(b) directing the first server to receive a selecting instruction which a user input for the first graph, and to compute a first location index of the first graph on the displaying interface of the application according to the selecting instruction;
(c) directing the first server to receive a second graph which the user selected from a prestored database, and the second graph is corresponding to a second graph identification number;
(d) directing the first server to replace the first graph on the displaying interface of the application with the second graph; and
(e) directing the first communication device to transmit the first location index and the second graph identification number to a second message host.

9. The method of claim 8, wherein in the step (e), the first communication device further transmits an application identification number and a user identification number to the second message host, wherein the second message host comprises a second server, and the first graph is input by another user and is transmitted to the first display by the second communication device in the step (a).

10. The method of claim 9, further including:
(f) directing the second server to select the second graph from a prestored database according to the second graph identification number, and to replace the first graph with the second graph according to the first location index.

11. The method of claim 10, wherein the second graph is a graph relative to the first graph.

12. The method of claim 11, wherein the second graph is a dynamic graph, and the initial state of the dynamic graph is the first graph.

13. A method for displaying text and graph message, performed between the first message host and the second message host, comprising:
sending a first graph from the first message host to the second message host;
storing the first graph to a first memory unit of the first message host when the first graph is not exist in the first memory unit;
storing the first graph of to the second memory unit of the second message host when the first graph is not exist in the second memory unit; and
generating a dynamic graph according to a second graph, a histrocial records and a predetermined displaying rule, wherein the histrocial records are the graphs stored in the first memory unit and the second memory unit.

14. The method of claim 13, further comprising step of the first message host sending the first message to the second message host when the first message is not a graph type message.

15. The method of claim 14, wherein the graph type message is selecting from a group consisting of a static image, dynamic image, a animation without voice, a animation with voice and virtual reality image.

16. The method of claim 13, wherein second graph is sent from either the first message host or the second message host.

17. The method of claim 13, wherein dynamic graph shows on the displaying interface for a period of time, or is interrupted by a interrupt message such as touching screen or click the mouse.

18. The method of claim 13, wherein the second graph replaces the first graph as a new first graph.
